(19) United States
(12) Patent Application Publication
(10) Pub. No.: US 2012/0186753 A1
(43) Pub. Date: Jul. 26, 2012

(54) Safer Roman Shade

(76) Inventor: Chung-Yuh Tsai, Taipei City (TW)

(21) Appl. No.: 13/014,110

(22) Filed: Jan. 26, 2011

(51) Int. Cl. A47H 5/00; F16G 11/00

(52) U.S. Cl. 160/84.04

(57) ABSTRACT

A roman shade includes a main body, a head rail, a bottom rail, a plurality of retractable tubes, a plurality of connectors, a plurality of eye screws, a cord lock and a plurality of cords. Each of the connectors is fixed at the bottom of each retractable tube. The cord lock is provided on one side of the head rail. One side of each cord passes through the eye screw into the cord lock and through a retractable tube to reach the connectors. Also, a ring is provided at the intersection of each horizontal pleat and each retractable tube, so that each shorter tube may be positioned and guided by the ring. Because the cords are hidden in the retractable tubes, the safety in home and the appearance of the shade may be enhanced.

### BACKGROUND OF THE INVENTION

1. Field of the Invention

The invention relates to a roman shade with cord-conceiving design in which the cords are hidden and that may be used for windows, doors, and similar openings. The design of the present invention should be applicable to any shades whose lifting cords need to be hidden.

2. Description of the Prior Art

In practice, curtain is installed onto a window or a door to block the sunlight and to ensure the privacy of the people living inside. Generally, there are two types of curtains: the curtain that is opened laterally, such as drapery panel; and the curtain that is opened upwardly, such as roman shade, venetian shades and so on.

Please refer to FIG. 6, which is a perspective view showing the roman shade of the prior art. A head rail system B is provided on the top of the shade A of the prior art. The shade fabric portion A1 is connected with the head rail system B. A plurality of horizontal pleats A2 are provided on the shade fabric portion A1. A plurality of cord rings A21 are provided on each pleat A2. A bottom rail A4 is connected to the lower end of the shade fabric portion A1. A lifting cord A3 passes through several cord rings A21 and is fixed by a cord tie-off bead A5 to the cord ring A21 located at the bottom horizontal pleat A2. The other end of the lifting cord A3 extends out of the head rail system B. Therefore, we can pull the lifting cords A3 downwards to pull the shade up.

Because the lifting cords A3 are loosely held by the cord rings A21, a child may be suffocated or strangulated to death by the strings when accidentally got strangled by the lifting cords A3.

To eliminate the disadvantage in the prior art, the inventor has put a lot of effort into the subject and has successfully come up with the roman shade of the present invention.

### SUMMARY OF THE INVENTION

The main object of the present invention is to provide a roman shade that can enhance the safety at home.

To reach this goal, the roman shade of the present invention is disclosed. The roman shade of the present invention comprises a main body, a head rail, a bottom rail, a plurality of retractable tubes with fixing mountings and connectors, a plurality of eye screws, a plurality of rings, and a cord lock and a plurality of cords. The main body comprises a plurality of horizontal pleats. The hanging portion is disposed on the head rail of the shade, and the bottom portion is disposed on the bottom rail of the shade. Each of the connectors is fixed at the bottom of each retractable tube. The eye screws are fixed on the head rail, and the number of the eye screws depends on the size of the shade. The cord lock is provided on one side of the head rail. One end of each cord passes through the eye screws then into the cord lock for operation, and through a retractable tube with fixing mounting fixed to the head rail. Also, a ring is provided at the intersection of each horizontal pleat and fixed each retractable tube to be on the track, so that each tube may be positioned and guided by the ring. Each of the connectors could be detached so that the retractable tubes may be retracted and that the shade may be folded up or stored away easily. Because the cords are hidden in the retractable tubes, which constrains the extensity of the cords hidden inside, the safety in home and the appearance may be enhanced.

In addition, the lower end of each of the shorter cylindrical tubes is provided with an inwardly extending horizontal portion, and the upper end of each of the shorter cylindrical tubes is provided with an outwardly extending horizontal portion which makes the retractable tubes be functional and positioned then prevent any possible strangle occurred when pulling the cords.

Moreover, a plurality of connectors are fixed at the bottom of each retractable tube and are detachable. The fixing mounting at the top side of the tubes is designed as a two-segment hinge and could rotate 360 degrees. This design enables the shade to be packed into a smaller package for easy storage and shipping.

### BRIEF DESCRIPTION OF THE DRAWINGS

FIG. 1 is a perspective view of the roman shade of the present invention.

FIG. 2 is a side view of the roman shade of the present invention.

FIG. 3 is a perspective view showing the roman shade of the present invention in use.

FIG. 3A is an enlarged view of part I in FIG. 3.

FIG. 3B is an enlarged view of part II in FIG. 3.

FIG. 4 is an optional design for the retractable tubes.

FIG. 5A is a first view illustrating how the retractable tubes may first be folded upwards and then be rotated horizontally.

FIG. 5B is a second view illustrating how the retractable tubes may first be folded upwards and then be rotated horizontally.

FIG. 5C is a third view illustrating how the retractable tubes may first be folded upwards and then be rotated horizontally.

FIG. 6 is a perspective view showing the roman shade of the prior art.

### DETAILED DESCRIPTION OF THE PREFERRED EMBODIMENT

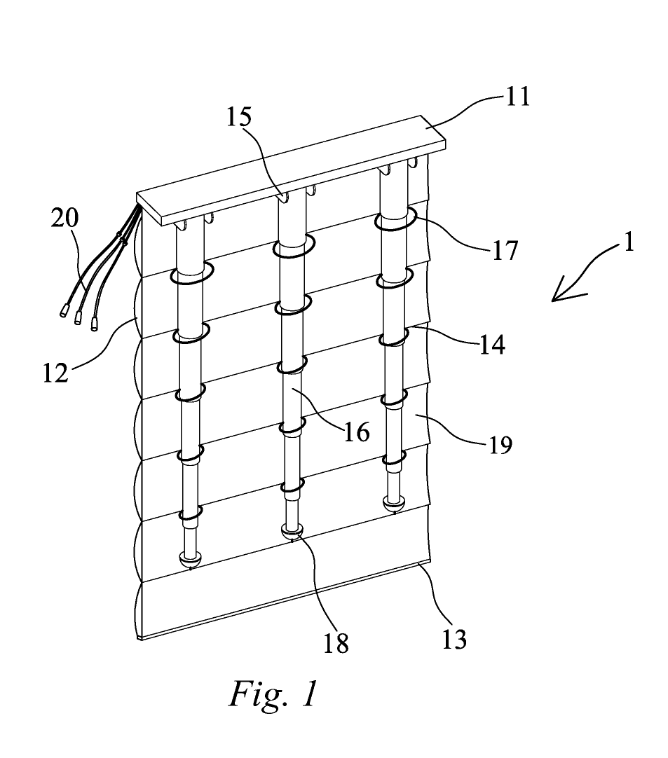

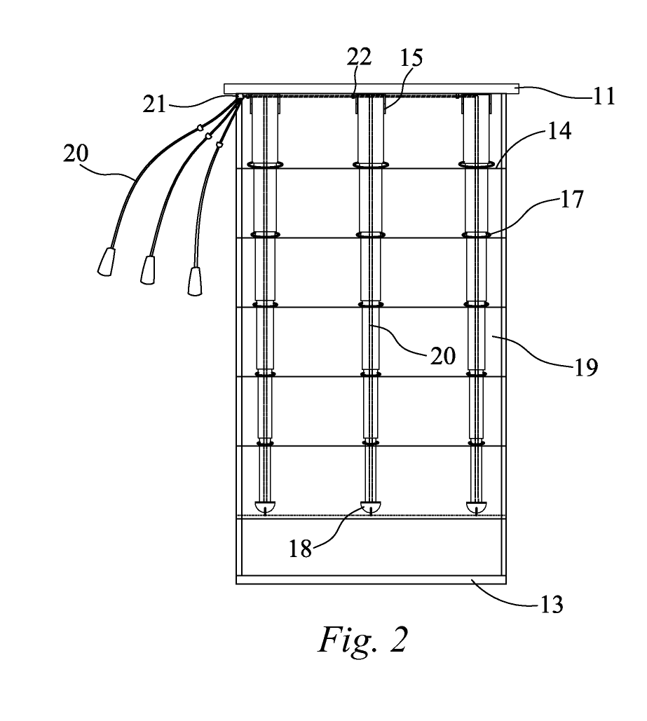

Please refer to FIG. 1. The roman shade 1 of the present invention comprises a shade main fabric 12, a liner 19, a head rail 11, a bottom rail 13, a plurality of horizontal pleats 14, a plurality of cords 20 and a plurality of retractable tubes 16. The liner 19 is provided on the back of the shade main fabric 12. The head rail 11 is disposed on the upper end of the shade 1, and the bottom rail 13 is disposed on the lower end of the shade 1. The horizontal pleats 14 are equally spaced apart. We can use the cords 20 to pull up or let down the shade 1. The number of the cords 20 and the retractable tubes 16 depend on the size of the shade 1. Therefore, each cord 20 corresponds to a retractable tube 16. A fixing mounting 15 connects each retractable tube 16 with the head rail 11. Each retractable tube 16 consists of several shorter tubes, and each tube has gradually decreasing diameter from one opening to another. Also, a connector 18 is fixed at the bottom of each retractable tube 16. An eye screw 22 is fixed on the head rail 11 and a cord lock 21 is provided on one side of the head rail 11 (please refer to FIG. 2). One end of each cord 20 is provided with a safety tab and a substantially truncated conical piece to connect with the shade. The other end passes through the eye screw 22 into the cord lock 21, and through a retractable tube 16 to reach the fixing mounting 15 fixed to the head rail 11. In addition, on the shade main fabric 12, a ring 17 is provided at the intersection of each horizontal pleat 14 and each retractable tube 16, so that each shorter tube may be positioned and guided by a ring 17 and so that we can use the cords 20 to move the shade main fabric 12 and the liner 19 up and down to operate the roman shade 1.

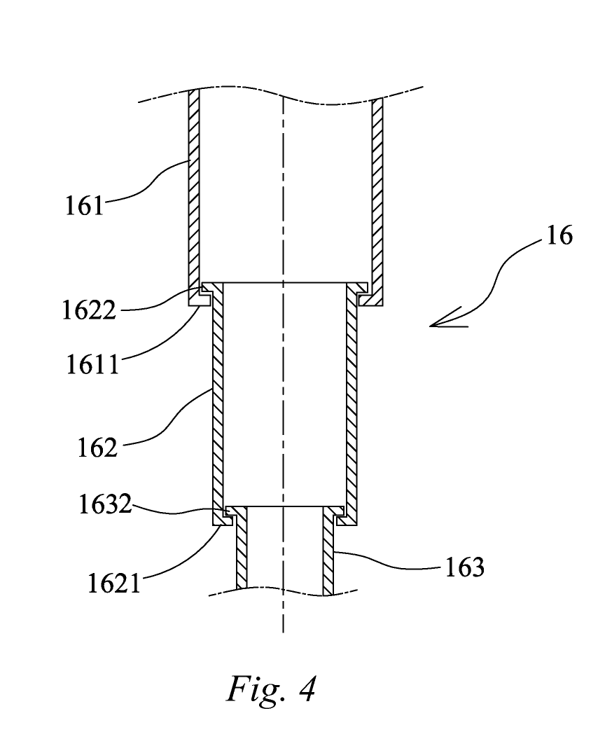

As previously described, each retractable tube 16 may consist of several shorter tubes, each of which has gradually tapering diameter from one opening to another. Alternatively, each retractable tube 16 may consist of several shorter tubes with different diameter. As illustrated in FIG. 4, a retractable tube 16 consists of several shorter tubes 161, 162 and 163. The diameter of tube 161 is greater than the diameter of tube 162, and the diameter of tube 162 is greater than the diameter of tube 163. In addition, the lower end of each of the shorter cylindrical tubes 161, 162 and 163 is provided with an inwardly extending horizontal portion 1611 and 1621; the upper end of each of the shorter cylindrical tubes 161, 162 and 163 is provided with an outwardly extending horizontal portion 1622 and 1632. Therefore, the tube 162 may be linked with the tube 161, and the tube 163 may be linked with the tube 162. Moreover, the horizontal portion 1611 and the horizontal portion 1622 may slightly press against each other and hence keep the two tubes 161 and 162 in position. Likewise, the horizontal portion 1621 and horizontal portion 1632 may slightly push against each other and hence keep the two tubes 162 and 163 in position. Whence, a retractable tube 16 may be formed.

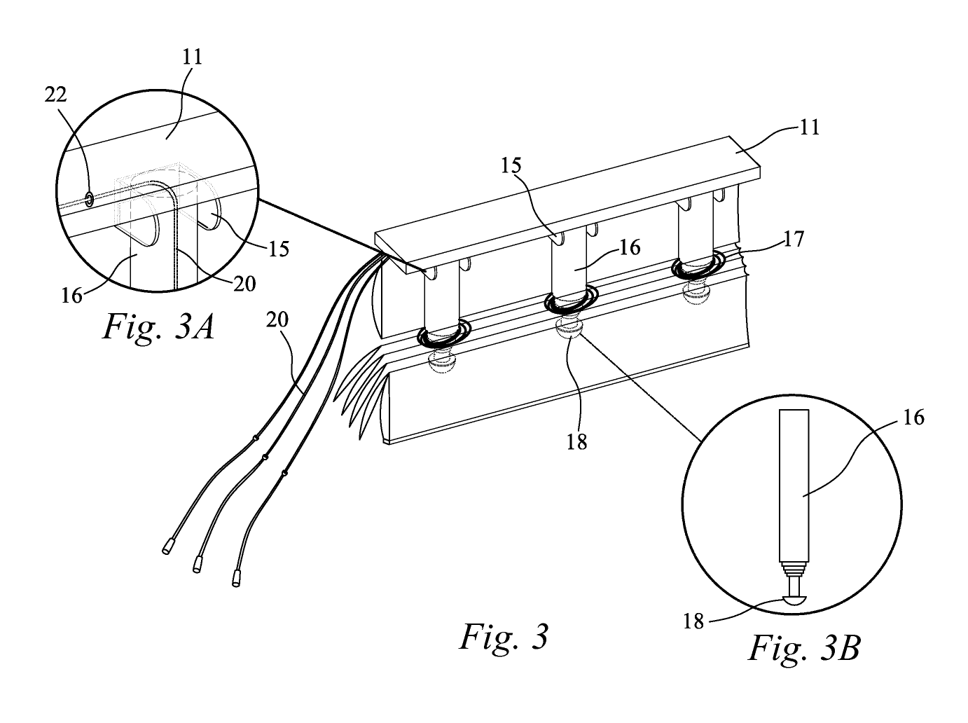

Please refer to FIG. 3. When we pull the cords 20 downwards, each cord 20 would pull up its connector 18, and the shorter tubes of the retractable tube 16 would start to retract from the bottom up until the shade main fabric 12 is pulled up to the level that we want. Then, we can let go of the cords 20 and allow the cords 20 to be fixedly held in position by the cord lock 21. Therefore, the shade main fabric 12 may be fixedly held at the said level. When we want to let down the shade main fabric 12, we just pull the cords 20 outwards so that the cord lock 21 may let go of the cords 20. The downward gravitational force due to the weight of the bottom rail 13 would prompt the shorter tubes of the retractable tube 16 to be extended downwards.

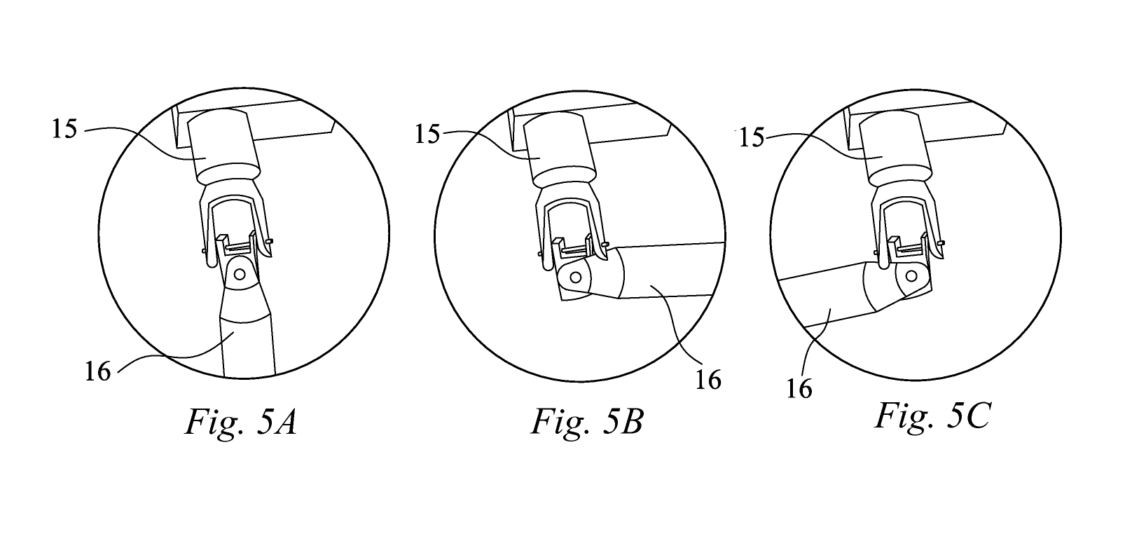

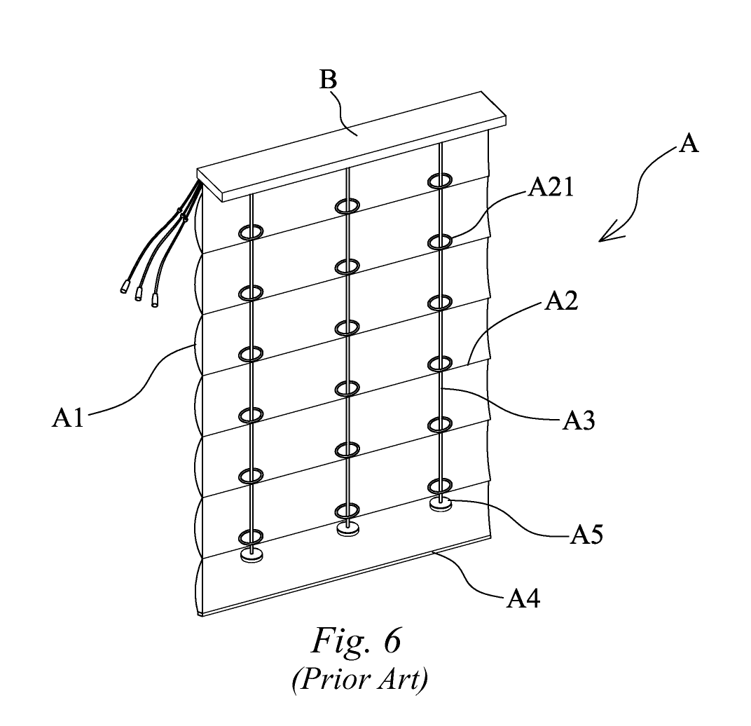

As illustrated in FIG. 5, each fixing mounting 15 is of two-segment hinge and may be rotated by 360 degrees. Therefore, when the roman shade 1 needs to be folded up and stored away, the retractable tubes 16 may first be folded upwards by 90 degrees with respect to the fixing mounting 15 and then be rotated horizontally by an appropriate angle. In this manner, the shade may be folded up into a smaller volume.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

From the above, we can see that the roman shade of the present invention meets the relevant patent requirements. It is hoped that the patent application will be approved.

What is claimed is:

1. A roman shade, comprising:
a main body, which comprises a plurality of horizontal pleats;
a head rail, disposed on the upper end of the shade;
a bottom rail, disposed on the lower end of the shade;
a plurality of retractable tubes, each retractable tube having a plurality of shorter cylindrical tubes;
a plurality of connectors, wherein each of the connectors is fixed at the bottom of each retractable tube;
a plurality of eye screws, fixed on the shade fabric, wherein the number of the eye screws depends on the size of the shade;
a cord lock, provided on one of the head rail; and a plurality of cords,
whereby one end of each cord passes through the eye screw into the cord lock and through a retractable tube to reach the connector; and that a ring is provided at the intersection of each horizontal pleat and each retractable tube, so that each shorter cylindrical tube is positioned and guided by the ring.

2. The roman shade as in claim 1, wherein the lower end of each of the shorter cylindrical tubes is provided with an inwardly extending horizontal portion and the upper end of each of the shorter cylindrical tubes is provided with an outwardly extending horizontal portion.

3. The roman shade as in claim 1, wherein the connector is fixed at the bottom of each retractable tube and is detachable, and wherein each fixing mounting is of two-segment hinge and may be rotated by 360 degrees and hence, when the roman shade needs to be folded up and stored away, the retractable tubes may first be folded upwards by 90 degrees with respect to the fixing mounting and then be rotated horizontally by an appropriate angle, and wherein in this manner, the shade may be folded up into a smaller volume.
